(19) United States
(12) Patent Application Publication
(10) Pub. No.: US 2009/0049993 A1
(43) Pub. Date: Feb. 26, 2009

(54) Waffle and pancake cooking apparatus

(76) Inventor: Fletcher Morgan, St. Petersburg, FL (US)

Correspondence Address: JOHN S. HALE;GIPPLE & HALE, 6665-A OLD DOMINION DRIVE, MCLEAN, VA, 22101, US

(21) Appl. No.: 11/892,496

(22) Filed: Aug. 23, 2007

(51) Int. Cl. A47J 37/06

(52) U.S. Cl. 99/375

(57) ABSTRACT

A cooking apparatus for batter based foods that can be inserted into the slot of a traditional toaster and cooked using the toaster's heating mechanism. The apparatus has two hingedly connected complimentary cooking members, that when closed one upon the other, define an interior cavity shaped in the form of the desired cooked product. A clamping mechanism is built into the handles of each of the two cooking members and an overflow reservoir is formed by each of the cooking members and is positioned between the handles to vent gasses, steam, and/or excess batter upward when the device is placed in the toaster for cooking, thereby protecting the interior mechanism of the toaster from spillage.

### RELATED APPLICATIONS

There are no related applications.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### FIELD OF THE INVENTION

The present invention generally relates to an insert member for a conventional toaster usable for cooking any liquid, semi-liquid, semi-solid, or batter material that solidifies with the application of heat. More specifically, this invention relates to cooking forms insertable in a conventional toaster, shaped to permit the cooking of foods that are liquid, semi-liquid, or semi-solid in their uncooked state, for example, breakfast foods such as waffles or pancakes.

### BACKGROUND OF THE INVENTION

The cooking of food products that start from a batter and subsequently solidify with the application of heat while cooking is well known. For example, so-called “waffle irons” are widely available for creating a crisp, flat, food item traditionally eaten during breakfast or as a dessert ingredient. The familiar rectangular or circular shape with multiple indentations is designed to advantageously contain various syrups, jams and jellies, or other condiments. Nevertheless, making “homemade” waffles or pancakes is a time consuming, equipment intensive undertaking generally reserved for weekends or special occasions. The process generally involves pulling a heavy, unwieldy, waffle iron or flat plate from storage in one of the kitchen cabinets (put there because the device is so rarely used and counter space is limited), plugging it in, greasing it, pre-heating it, mixing the batter, lifting the iron's top and pouring the batter in, closing the top and waiting a sufficient time for cooking. Thereafter, clean-up can be equally daunting because these cookware devices cannot be put into the dishwasher or submerged in the sink. Hence, they are generally wiped clean as best as possible instead of being washed, thereby increasing the likelihood of bacterial colonization, and placed back into the dark confines of the kitchen cabinet, further increasing the opportunity for the growth fungi and bacteria. Similarly, pancakes or griddle cakes are slightly less problematic to cook but equally time consuming and messy to prepare.

What is needed is a cooking appliance that can quickly and easily cook batter-based food items, yet is easy to manipulate and clean, and optimally, can make use of existing kitchen appliances in order to maximize their efficiency and conserve counter space. The prior art is replete with various waffle and pancake making devices. The instant invention solves the above noted disadvantages.

A number of cooking devices are shown in the prior art. U.S. Pat. No. 1,546,347 issued 9 Jan. 1923 is a waffle iron that cooks waffles in a generally vertical orientation. This device is a large, counter-top appliance utilizing the familiar clamshell-like configuration used commonly in current waffle makers. Flat, textured cooking surfaces are joined at a hinged connection in a vertical orientation. These cooking surfaces are pressed together while cooking, then separated when cooking is complete in order to permit access to the food item within. The traditional means of using these waffle cooking devices is that an appropriate amount of batter is poured onto one cooking surface, thereafter the other surface is closed upon it until cooking is complete. This device is used by first closing the cooking surfaces against one another, then filling the device via its fill spout, and cooking.

U.S. Pat. No. 5,596,922 issued 28 Jan. 1997 is a hamburger grilling appliance including a bifurcated sidewall assembly that effectively seals the device while cooking but allows easy access to the cooked food when the device is opened, thereby facilitating removal of the cooked product. It is inappropriate for use with batters, however, with a problem of leakage of the uncooked material.

### SUMMARY OF THE INVENTION

The present invention is an insert for conventional toasters enabling the user to cook batter-based foods, for example, waffles and pancakes, using the toaster's heating mechanism. It solves the aforementioned problems in the prior art regarding unwieldiness or difficulty in cleaning up, and additionally makes more efficient use of an already existing kitchen appliance. It includes two hingedly connected complimentary cooking surfaces, that when closed one upon the other, define an interior volume shaped in the form of the desired product, for example a waffle or pancake. Additional features include a clamping mechanism built into the handles and an overflow reservoir positioned to vent gasses, steam, and/or contain excess batter when the device is placed in the toaster for cooking, thereby protecting the interior mechanism of the toaster from spillage or other deleterious materials which may ultimately affect its functioning. The handles may also serve as a means of suspending the device within the toaster slot in the event that the aforementioned slot is particularly deep and/or the desired food product is designed to be significantly smaller in one dimension compared to the depth of the aforementioned slot. This placement additionally enables easier manipulation of the entire device, for example, when opening the device and removing the cooked food product.

It is an object of the invention to provide a device that is easy to clean, and because it relies upon the heating source within the toaster, the entire device is dishwasher safe.

It is another object of the invention to provide a device that is light in weight and takes up little space for storage.

It is yet another object of the invention that it will permit the existing toaster that users already own to function in multiple roles, thereby eliminating the need for traditional electric waffle iron and its attendant inconveniences.

The invention will be better understood and objects other than those set forth above will become apparent when consideration is given to the following detailed description thereof. Such description makes reference to the annexed drawings wherein.

### BRIEF DESCRIPTION OF THE DRAWINGS

FIG. 1 is a perspective view of the waffle maker invention showing the entire cooking form assembly when filled and closed.

FIG. 2 is an enlarged side elevation view of the invention shown in FIG. 1.

FIG. 3 is a top plan view of the invention shown in FIG. 1.

FIG. 4 is an enlarged sectioned side elevation view of a base member of the invention.

FIG. 5 is a plan view of the base member of the invention with handles removed depicting its non-stick coated cooking surface.

FIG. 6 is a plan view of the cover member of the invention with handles removed depicting its non-stick coated cooking surface.

FIG. 6A is an enlarged side elevation view of the cover member shown in FIG. 6.

FIG. 7 is a side elevation view of the handle assembly.

FIG. 8 is a top plan view of the handle assembly in FIG. 7.

FIG. 9 is an end view of the handle assembly in FIG. 7.

FIG. 10 is a plan view of the handle assembly as shown in FIG. 10.

FIG. 11 is a detailed side elevation of the handle assembly in FIG. 7 without the silicone insulating cushion depicted in FIG. 7.

FIG. 12 is a perspective plan view of a pancake maker in a closed position.

FIG. 13 is a front end view of the pancake maker shown in FIG. 12.

FIG. 14 is rear end view of the pancake maker shown in FIG. 12, and

FIG. 15 is an enlarged side elevation view of the pancake maker shown in FIG. 12.

### DETAILED DESCRIPTION OF THE INVENTION

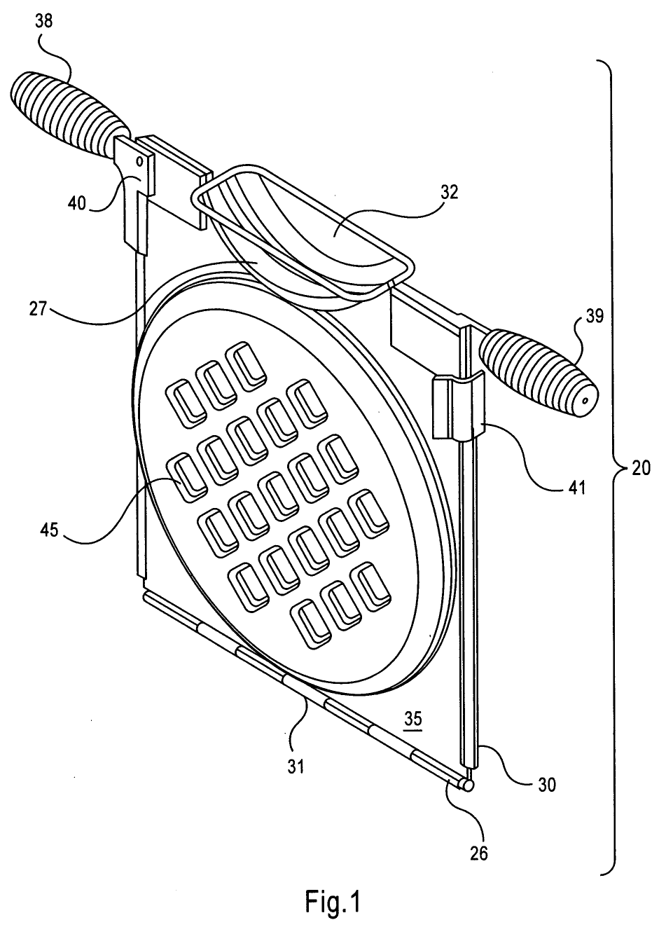

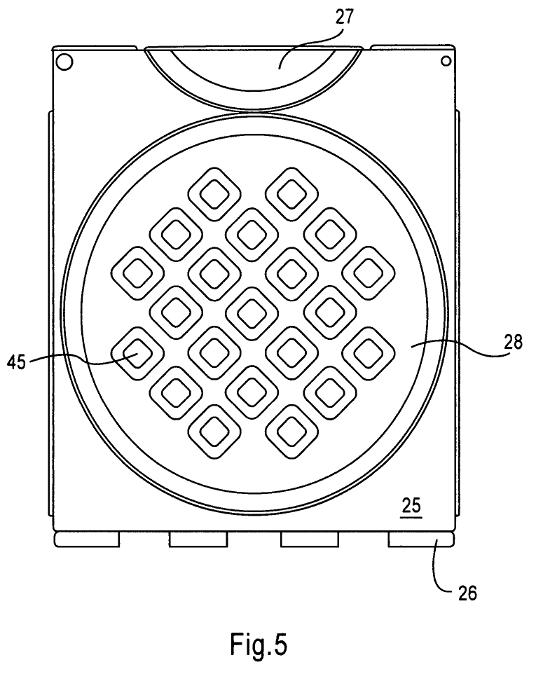

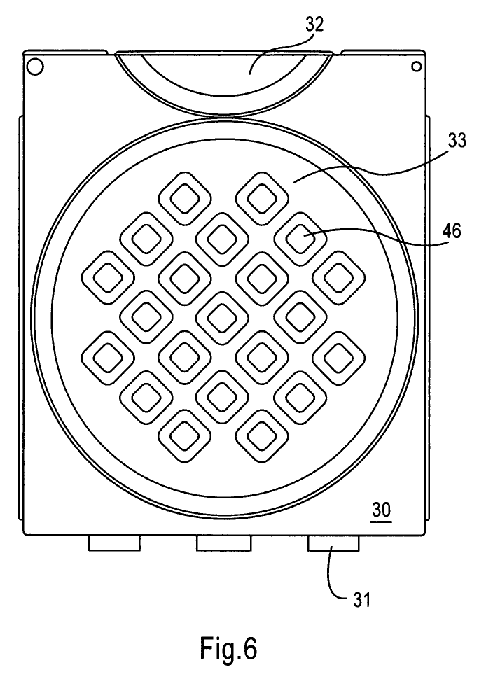

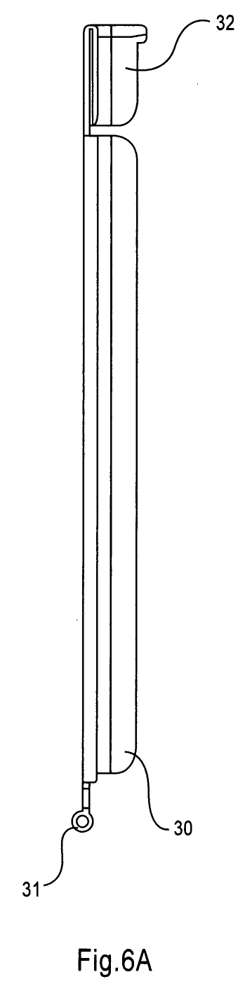

The preferred embodiments and best modes of the invention are shown in FIGS. 1 through 11. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

This invention may be constructed from any heat resistant, yet heat conductive material. Such heat conductive materials have been made from metallic material, including aluminum for the primary cooking elements. However, it is noted that this invention may also successfully using sheet steel, stainless steel, copper, cast iron, Pyrex® (or similar borosilicate glass), porcelain, ceramic, or polymeric material. The cooking surfaces are also preferably coated with one or more non-stick coatings, for example Teflon® (i.e., fluorocarbon polymers), (e.g., tetrafluoroethylene and fluorinated ethylene propylene).

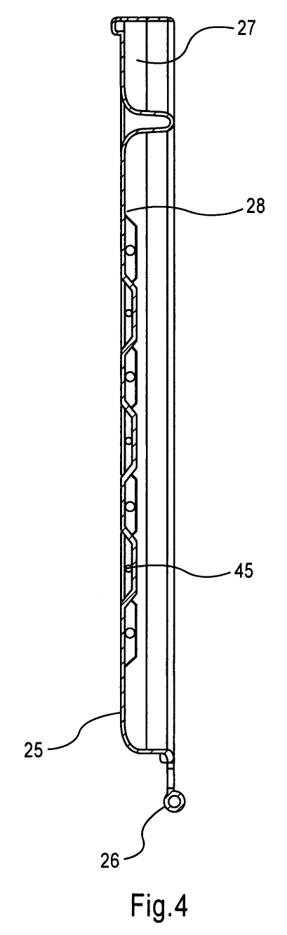

The present cooking device 20 includes a base member 25 having a hinge 26 at one end and cover member 30 with a hinge 31 at a corresponding end. Not shown is a hinge pin interconnecting the aforementioned hinge elements 26, 31, which are themselves incorporated into the base member 25 and cover member 30. A cooking cavity 28 best shown in FIG. 4 is shaped in the relief of the form of the food product to be cooked. Additionally, a plurality of square shaped protuberances 45 with tapered side walls 46 and a top planar surface 47 extend outward from the cooking surface to form the waffle embodiment. Each adjacent protuberance in linear alignment ranges from about 0.55 inches to about 0.75 inches from center point to center point of each protuberance. In a most preferred arrangement, the protuberances 45 are spaced about 0.65 inches apart. A complimentary cooking cavity 33 is also present in the cover member 30. The aforementioned members 25, 30 and cavities 28, 33 are shaped to define complimentary portions of the final form of the cooked food material. The entire cooking apparatus 20 is sized for insertion into a conventional toaster. The base member 25 and cover member 30, when closed, define a substantially sealed cavity shaped in the desired final form of the food product to be cooked. It is an important feature of this invention that the aforementioned compartment is substantially sealed in order to effectively contain food material placed therein, but permits sufficient leakage at the seam for venting steam or excess batter during the cooking process. The batter leaking into the seam between base member 25 and cover member 30 in effect becomes its own sealant, thereby preventing leakage of additional material into the heat source, typically a conventional toaster. In practice, metal (or other heat resistant but heat conductive material) in the vicinity of the seam or sealing area will heat rapidly because it is not in direct contact with the batter. As batter leakage occurs into the seam, the batter contacts this relatively highly heated material and immediately solidifies, thereby creating its own seal thus preventing leakage of additional batter. An area of the cooking apparatus which operates differently in this regard is the top or overflow reservoir cup area located between the handles.

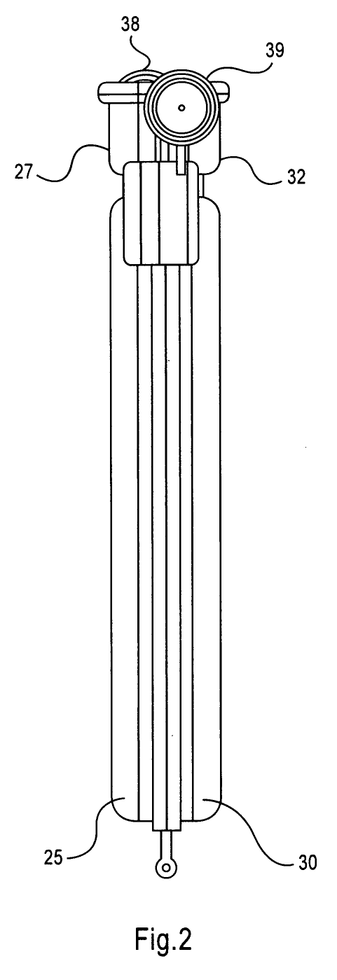

An overflow reservoir or cup 50 is defined by the two end cup halves 27, 32 defined in the base member 25 and cover 30 shown in FIGS. 1 and 2. In use, steam created by the cooking process tends to rise, following a path in the direction of the cup 50. Consequently, excess batter follows this path of lower resistance and since a seal has not been formed, tends to collect in the cup 50.

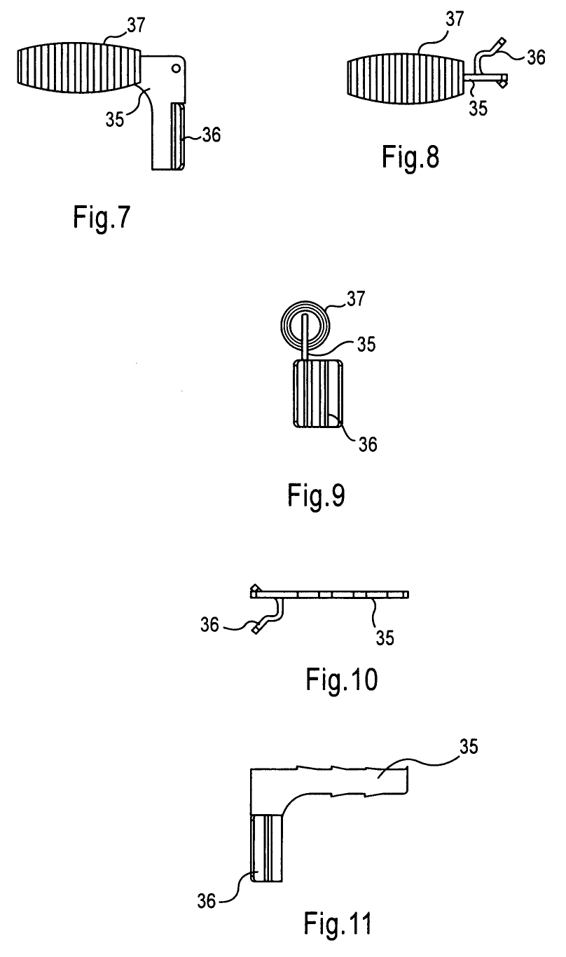

Another important feature of this invention is the placement of its handles 38, 39 and the clamping feature formed by the handles. As illustrated in FIGS. 1, 2, and 3, L shaped handles 38, 39 are preferably positioned at the opposite end of base member 25 and cover member 30, away from the hinge 26, 31. The handles 38, 39 are generally co-axial when the apparatus is in its closed position and ready for insertion as shown in FIG. 2. Hence, when in a closed position, the handles 38, 39 are ideally positioned for easy insertion or extraction of the apparatus from a toaster slot. The handles are individually mounted on the base and cover members 25, 30, such that when the device is open, one handle 38 is mounted to the base member 25, with the other handle 39 mounted to the cover member 30. Handling characteristics of the apparatus are thereby maximized whether opened or closed, consequently obviating any need for oven mitts, hot pads, or the like. In use, all required manipulation of the device may be accomplished using the handles exclusively. The handles have one leg 36 which has a generally U shaped configuration as is shown in FIGS. 7, 8, and 9 and acts as a clamp with an insulating silicone grip or cushion 37 mounted on the other leg.

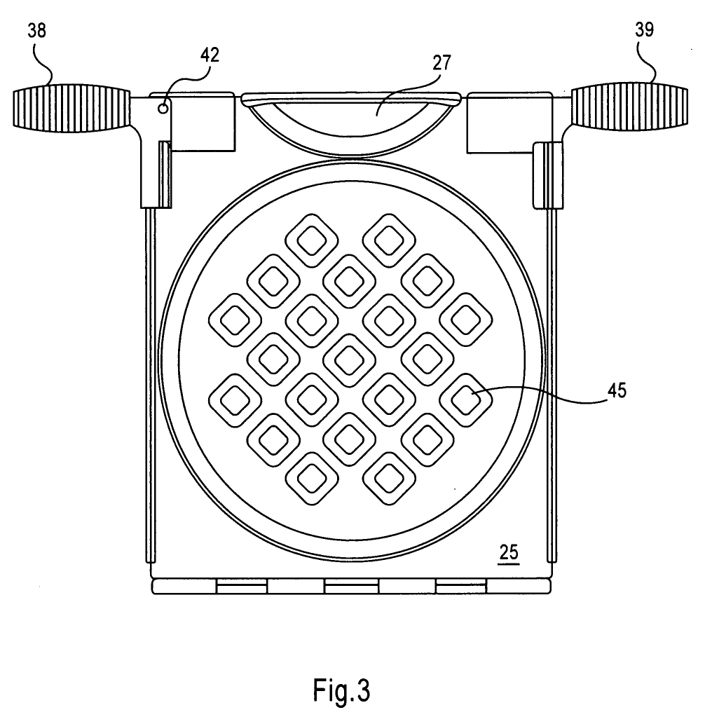

A handle attaching pin 42 permits rotational or pivoting movement of the handle 38 attached to the base member 25 as shown in FIG. 3. Not shown is a similar pin mounting its respective handle 39 to cover member 30. The handles 38, 39 each have a clamping leg member 36 manufactured from a resilient material, sized to fit over the combined thicknesses of the base and cover members 25, 30 when closed. In use, the handles 38 and 39 and their respective leg clamp members 36 are rotated around pin 42 away from the base and cover members 25, 30 so that the cooking apparatus 20 may be opened. In closing, the handles and their respective leg clamps are rotated downward with the leg clamps 36 frictionally moving over the top portion of the base and cover members, thereby locking the base and cover members 25, 30 into their respective closed positions, ready for insertion into the toaster.

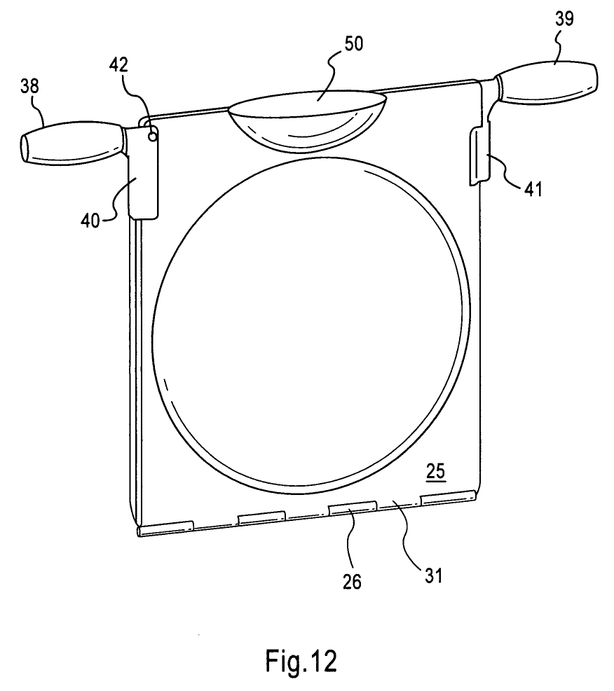

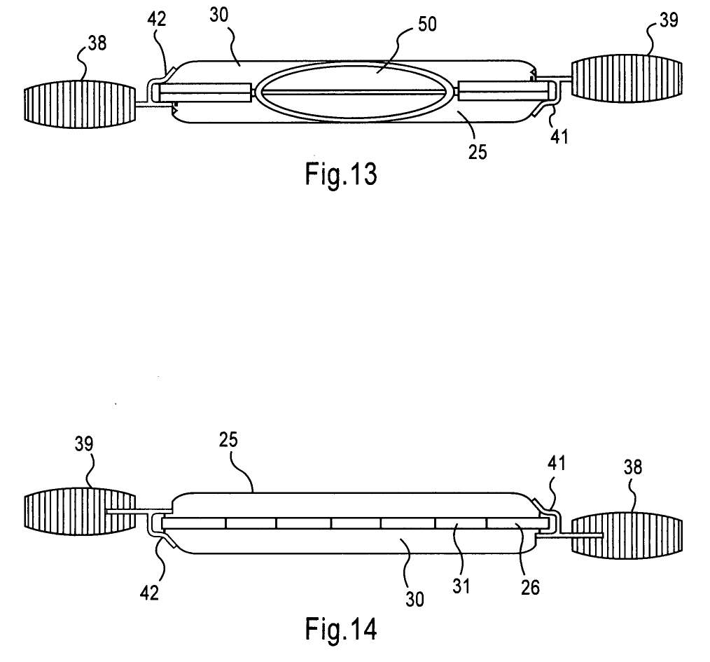

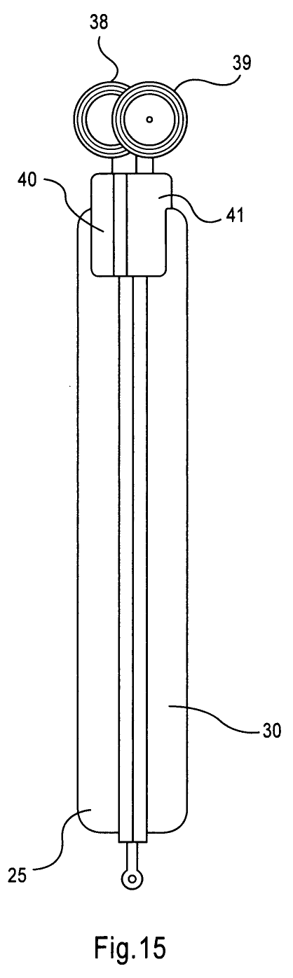

FIGS. 12 through 15 are drawings show a pancake making assembly 60 using the same structural components as previously discussed without the waffle protuberances 45. This assembly has a central cavity with a curved side wall 62 and a planar end wall. 64.

Handles 38, 39 and clamping members 40, and 41 are rotated away from base member 25 and cover member 30 in order to open the device. The now open apparatus may be placed on a table or countertop, and either the base member 25 or cover member 30 filled with an appropriate amount of batter. The unfilled member is rotated about hinge 26, 31 and allowed to rest atop the filled member. Handles 38, 39 are rotated inward, towards the now adjacent base and cover members 25, 30, and clamps 40, and 41 rotate on pin 42 to lock the base member and cover member together. The entire assembly is then placed into a conventional toaster, wherein heat produced therein cooks the batter in the cooking cavity. Small amounts of batter may leak due to imperfect sealing at the interface of said base member 25 and cover member 30, but the apparatus self seals by solidifying instantly upon coming in contact with the comparatively highly heated portions of the base and cover members 25, 30 not previously in contact with the batter. Steam or other byproducts of the cooking process tend to vent upward into the portion of the base and cover members 27, 32 that form the overflow reservoir 50. Excess batter will tend to follow this path of less resistance, thereby tending to collect into said overflow reservoir 50 rather than into the toaster, thereby simplifying cleanup.

It is noted that the critical features of this invention are equally amenable for use with regard to cooking any batter-based product that solidifies with the application of heat. The specific embodiments described herein include waffle making and pancake making incarnations, but are not limited to same. Moreover, it is understood that while this invention is ideally suited for use in a conventional toaster, this invention may be used with any heat source with little or no modification. For example, this invention may be equally useful in conjunction with an open flame, so-called toaster oven, or conventional oven.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What I claim is:

1. A cooking apparatus comprising:
a base member defining a cavity adapted to receive food material;
a cover member defining a complimentary cavity adapted to receive food material;
hinge means connecting said base member and said cover member;
an overflow reservoir means mounted on said cover member and said base member away from said hinge means; and
handle means mounted to said base member and said cover member adapted to clamp the same together.

2. A cooking apparatus as claimed in claim 1 wherein said base member and said cover member are sized for use in a conventional toaster

3. A cooking apparatus as claimed in claim 1 wherein said handle means comprises a first handle assembly rotatably mounted to said base member and a second handle assembly rotatably mounted to said cover member.

4. A cooking apparatus as claimed in claim 3 wherein said first handle assembly and said second handle assembly are L shaped with one leg of said assemblies forming a resilient U shaped portion.

5. A cooking apparatus as claimed in claim 1 wherein said base member and said cover member each have a handle assembly with a clamping section.

6. A cooking apparatus as claimed in claim 1 wherein said base member and said cover member define a plurality of protuberances extending toward each respective cavity of the other member.

7. A cooking apparatus as claimed in claim 1 wherein at least one of said members cavity is lined with a non-stick coating.

8. A cooking apparatus as claimed in claim 1 wherein said handle means is covered by a silicone covering.

9. A cooking apparatus comprising:
a base member defining a cavity with a substantially planar surface adapted to receive food material;
a cover member defining a complimentary cavity with a substantially planar surface adapted to receive food material;
hinge means connecting said base member and said cover member together;
an overflow cup positioned away from said hinge means with a portion of said overflow cup being defined by said base member and a portion of said overflow cup being defined by said cover member;
a first handle means rotatably mounted to said base member adapted to clamp and hold said base member adjacent to said cover member;
a second handle means rotatably mounted to said cover member adapted to clamp and hold said cover member adjacent to said base member;
said base member and said cover member defining a substantially sealed cooking cavity with a contiguous sidewall.

10. A cooking apparatus as claimed in claim 9 wherein said cooking apparatus is sized for use in a conventional toaster.

11. A cooking apparatus as claimed in claim 9 wherein said first handle means and said second handle means are covered with a silicone covering.

12. A cooking apparatus as claimed in claim 9 wherein said first handle means and said second handle means are mounted substantially co-axially away from said hinge means.

13. A cooking apparatus as claimed in claim 9 wherein at least one of said cavities is lined with a non-stick coating.

14. A cooking apparatus as claimed in claim 9 wherein said cover and base member surfaces include a plurality of equidistantly spaced protuberances which extend said member cavity forming a waffle pattern.

15. A cooking apparatus as claimed in claim 9 wherein said surfaces include a plurality of protuberances spaced between about 0.55 to about 0.75 inches, from one another measured from center to center of adjacent linear protuberances.

16. A cooking apparatus comprising:
a base member defining a cavity with a substantially planar surface adapted to receive food material;
a cover member defining a complimentary cavity with a substantially planar surface adapted to receive food material;
hinge means connecting said base member and said cover member;
an overflow reservoir comprising one half of a cup member integrally formed on each of said base member and said cover member;
a first handle means pivotally mounted to said base member by pin means adapted to clamp said base member adjacent to said cover member;
a second handle means pivotally mounted to said cover member by pin means adapted to clamp said cover member adjacent to said base member;
said base member and said cover member when closed defining a substantially sealed cavity defined by substantially planar surface, of said base member; and, a substantially planar second surface of said cover member with a contiguous sidewall joining said planar surfaces.

17. A cooking apparatus as claimed in claim 16 wherein said handle means is covered by a silicone covering.

18. A cooking apparatus as claimed in claim 16 wherein said first handle means and said second handle means are mounted away from said hinge means on opposite ends of said cover member and said base member.

19. A cooking apparatus as claimed in claim 16 wherein said base member and said cover member are lockable

20. A cooking apparatus as claimed in claim 16 wherein said substantially sealed cavity is lined with a non-stick coating.
